(19) United States
(12) Patent Application Publication
(10) Pub. No.: US 2002/0020087 A1
(43) Pub. Date: Feb. 21, 2002

(54) Graduation cap-shaped holding device

(76) Inventor: Cheryl J. Griffith, Bentleyville, PA (US)

Correspondence Address: Richard L. Byrne, 700 Koppers Building, 436 Seventh Avenue, Pittsburgh, PA, 15219-1818, US

(21) Appl. No.: 09/829,604

(22) Filed: Apr. 10, 2001

Related U.S. Application Data
(60) Provisional application No. 60/195,798, filed on Apr. 10, 2000.

(51) Int. Cl. G09F 1/10

(52) U.S. Cl. 40/124.4

(57) ABSTRACT

Disclosed is a graduation cap-shaped holding device for holding greeting cards and the like, and includes a cylindrical side portion having an upper edge and a lower edge. A square-shaped top portion is configured to rest on the upper edge of the cylindrical side portion. The top portion has a slot to receive an object, such as the greeting card, or allow the object to pass through the slot.

### BACKGROUND OF THE INVENTION

1. Field of the Invention

The present invention relates generally to holding devices, and, in particular, to a holding device adapted to receive greeting cards or the like for graduation-type celebrations.

2. Description of the Prior Art

A typical gift at a celebratory function, such as a graduation party or the like, takes the form of a greeting card or other envelope containing a monetary gift. As the greeting cards and envelopes collect in an area, they are prone to loss or misdirection. As such, an intended gift is lost, and the intended owner loses the benefit.

In order to alleviate this problem, different card holding devices have been developed. For example, U.S. Pat. No. 4,852,280 to Beattie discloses a card holding and displaying apparatus which uses strands of cord to hold the spine of the card. As another example, U.S. Pat. No. 5,012,966 to Turner et al. discloses a card holding device which is adapted to attach to a shopping cart and hold greeting cards, magazines and other materials.

### SUMMARY OF INVENTION

It is therefore an object of the present invention to provide a holding device that is shaped liked a graduation cap and is particularly suited for use at graduation parties. It is another object of the present invention to provide a graduation cap-shaped holding device that is practical, easy to use and convenient. It is another object of the present invention to provide a graduation cap-shaped holding device that is cost-effective to manufacture and easy to produce, package and assemble. It is a still further object of the present invention to provide a graduation cap-shaped holding device that would eliminate the loss or misplacement of greeting cards and envelopes, allowing the recipient to store and track their whereabouts.

Accordingly, I have invented a graduation cap-holding device that includes a cylindrical side portion having an upper edge and a lower edge, and a square-shaped top portion. The square-shaped top portion is configured to rest on the upper edge of the cylindrical side portion. Further, the top portion has a slot to receive an object or allow the object to pass through the slot. Typically, the object is a greeting card, envelope or other flat item. The overall shape and appearance of the present invention, when assembled, is that of a typical graduation cap.

In a preferred embodiment, the graduation cap-shaped holding device includes a top portion, a bottom portion, a side portion and a retainer element. The top portion is a rigid, flat, square-shaped part, with a slot centrally located on the top portion. The slot is configured to receive or allow to pass therethrough greeting cards, envelopes and similar objects. Further, one side of the top portion has positioning elements attached, which allow the top portion to be rested upon the side portion and to be easily removed therefrom. The top portion also has a tassel retainer orifice positioned near the slot to allow attachment of the retainer element to the top portion. In addition, when assembled, the user may attach a graduation tassel to the present invention via the retainer element.

The retainer element is circular and on one side of the retainer element is an attachment retainer. This attachment retainer is adapted to allow an attaching element, such as a bendable wire, twist-tie or the like, to be inserted through an attachment retainer orifice. When assembled, the retainer element may be attached to the top portion via the tassel retainer orifice, while at the same time secure a graduation tassel to the top portion.

In the preferred embodiment, the side portion is an elongated, flat structure with side orifices, which allow one end of the side portion to be attached to the other end via, for example, bolts and nuts, creating a cylindrical shape. Further, at the base of the inner side of the side portion is a bottom portion retainer, such as a foam or other ledge, which is configured to hold the bottom portion in place after insertion into the now-cylindrical side portion.

In order to assemble the present invention, one end of the side portion is attached to the other end of the side portion, with the bottom portion retainer running along the inner base of the now-cylindrical side portion. The ends of the side portion are attached via the side orifices with nuts and bolts or any other suitable fastening mechanism. Next, the bottom portion is inserted into the now-cylindrical side portion, allowing the bottom portion to securely rest upon the bottom portion retainer. The retainer element is attached to the top portion by inserting and spreading the bendable wire (which is connected to the attachment retainer, and therefore the retainer element via the attachment retainer orifice) through the tassel retainer orifice. After attachment of the retainer element, a graduation tassel may be secured to the top portion, using the retainer element as a button element. Finally, the top portion is rested on the now-cylindrical side portion, utilizing the positioning elements to removably mount the top portion on the side portion.

Once assembled, the present invention appears substantially similar to a typical, but oversized, graduation cap. The present invention is then placed on a table at the party, and the guests may use the slot to insert greeting cards and envelopes into the present invention. Overall, the present invention is an easy-to-manufacture, easy-to assemble and aesthetically pleasing card holding device for a graduation party.

### BRIEF DESCRIPTION OF THE DRAWINGS

FIG. 1a is a bottom view of a top portion of a holding device according to the present invention;

FIG. 1b is a top view of the top portion shown in FIG. 1a;

FIG. 1c is a side view of the top portion shown in FIG. 1a;

FIG. 2a is a top view of a retainer element of the holding device according to the present invention;

FIG. 2b is a bottom view of the retainer element shown in FIG. 2a;

FIG. 2c is a side view of the retainer element shown in FIG. 2a;

FIG. 2d is another side view of the retainer element shown in FIG. 2a;

FIG. 3 is a side view of an attaching element configured to be inserted through an attachment retainer orifice on the attachment retainer of the retainer element shown in FIG. 2a;

FIG. 4a is a back view of a side portion of the holding device according to the present invention;

FIG. 4b is a front view of the side portion shown in FIG. 4a;

FIG. 5 is a top view of a bottom portion of the holding device according to the present invention;

FIG. 6 is an exploded perspective view of the holding device according to the present invention;

FIG. 7 is a perspective view of the holding device according to the present invention with a graduation tassel attached to the top portion of the holding device;

FIG. 8a is a top view of an assembled holding device according to the present invention;

FIG. 8b is a bottom view of the assembled holding device shown in FIG. 8a;

FIG. 8c is a side view of the assembled holding device shown in FIG. 8a;

FIG. 8d is a second side view of the assembled holding device shown in FIG. 8a;

FIG. 8e is a back edge view of the assembled holding device shown in FIG. 8a;

FIG. 8f is a front edge view of the assembled holding device shown in FIG. 8a; and

FIG. 9 is a perspective view of the assembled holding device shown in FIGS. 8a-8f.

### DETAILED DESCRIPTION OF THE PREFERRED EMBODIMENTS

The present invention is a graduation cap-shaped holding device 10 and includes a square-shaped top portion 12 and a cylindrical side portion 14. The top portion 12 rests on the side portion 14, such that the top portion 12 and side portion 14 taken together are of a shape and appearance of a typical graduation cap. In addition, the top portion 12 has a slot 24 to receive an object or allow the object to pass through the slot 24. While the object is typically a graduation card, it may also be any other card, envelope, note, money or other flat item.

In a preferred embodiment, as seen in FIGS. 1-9, the graduation cap-shaped holding device 10 includes the top portion 12, the side portion 14, a bottom portion 16 and a retainer element 18. As seen in FIG. 1, the top portion 12 is a flat, rigid, rectangular object with a top portion upper surface 20 and a top portion lower surface 22. The top portion 12 may be constructed of plastic, cardboard, or any other suitable, durable material.

The top portion upper surface 20, illustrated in FIG. 1b, has a centrally located slot 24 running through the top portion upper surface 20. The slot 24 is configured to allow greeting cards, envelopes and other flat items to be inserted through the slot 24. Located adjacent the slot 24 is a tassel retainer orifice 26 which is preferably a circular opening. It is also envisioned that both the slot 24 and the tassel retainer orifice 26 may be of varying shapes and sizes.

The top portion lower surface 22, as seen in Figs. 1b and 1c, has multiple positioning elements 28 and 56 fixedly attached to and extending outwardly from the top portion lower surface 22. Weight bearing positioning elements 28 may be larger in length and diameter than side positioning elements 56. In operation, the weight bearing positioning elements 28 and the side positioning elements 56 are used to rest the top portion 12 on the side portion 14. In a preferred embodiment, the weight bearing positioning elements 28 are cork members glued to the top portion lower surface 22. However, any element that holds the top portion 12 on the side portion 14 in a secure but removable manner is envisioned. Similarly, in a preferred embodiment, the side positioning elements 56 are circular felt members, but may also be any other type of member which prevents the top portion 12 from being “bumped” off of the side portion 14. In operation, these positioning elements 28 are used to rest the top portion 12 on the side portion 14.

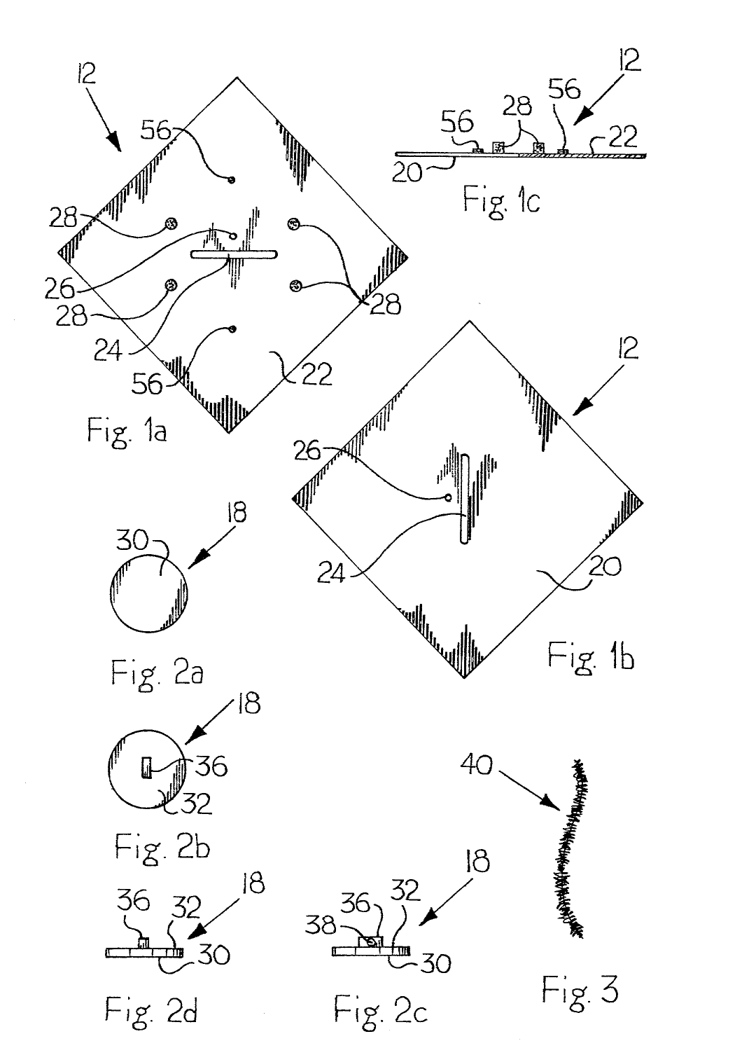

As shown in FIG. 2, the retainer element 18 is a circular, button-shaped element with a retainer element upper surface 30 and a retainer element lower surface 32. An attachment retainer 36 is affixed centrally to the retainer element lower surface 32. The attachment retainer 36 is a substantially rectangular object with an attachment retainer orifice 38 running through the attachment retainer 36. The attachment retainer orifice 38 is preferably circular and adapted to receive an attaching element 40, preferably a bendable wire, illustrated in FIG. 3, through the attachment retainer orifice 38. The retainer element 18 may be plastic, cardboard or any other suitable material, while the attaching element 40 may be wire, a twist-tie or other suitable element. When assembled, the retainer element 18 may be attached to the top portion 12 through the tassel retainer orifice 26, while, at the same time, secure a graduation tassel 58 to the top portion 12.

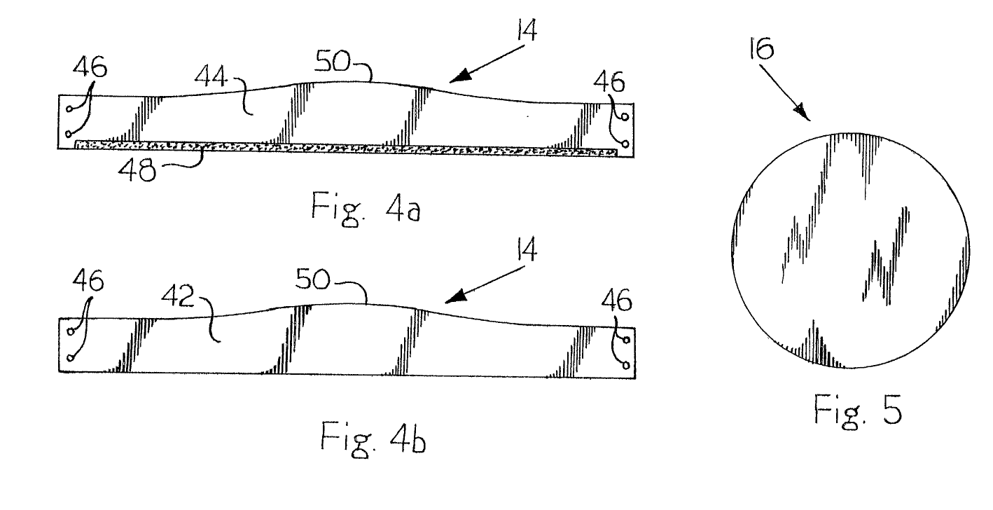

The side portion 14 is illustrated in FIG. 4 and has a side portion outside surface 42 and a side portion inside surface 44. The side portion 14 is an elongated, flat element with side orifices 46 running through each end of the side portion 14. Further, an upper edge 50 of the side portion 14 is centrally elevated. The side orifices 46 are preferably circular in shape and are adapted to align when the side portion 14 is “bent”, curled or otherwise formed into a cylindrical shape. Alternatively, the side portion 14 may be formed or manufactured in a cylindrical shape.

When the side portion 14 is cylindrically curled, the side orifices 46 provide points of fixation, in turn allowing the now-cylindrical side portion 14 to remain cylindrical. If the side portion 14 was pre-formed, the side orifices 46 would not be required. Also, in its cylindrical shape, the top portion 12 has a slanted upper edge 50 upon which the top portion 12 may be rested. Once the top portion 12 is rested on the now-cylindrical side portion 14, the weight bearing positioning elements 28 are used to hold the top portion 12 steady at the upper and lower regions of the slanted upper edge 50. Likewise, the side positioning elements 56 are used to stop lateral movement of the top portion 12.

Running longitudinally at or near a lower edge 43 of the side portion inside surface 44 is a bottom retainer 48. The bottom retainer 48 does not run the entire length of the side portion inside surface 44, instead it stops short of the area adjacent the side orifices 46. In this manner, when the side portion 14 is “bent” into a cylindrical shape, the ends of the bottom retainer 48 will be adjacent to, but not overlapping each other. In operation, the bottom retainer 48 acts as a ridge or ledge, allowing the now-cylindrical side portion 14 to support the bottom portion 16 placed thereon. It is envisioned that the side portion 14 may be plastic or other bendable material, while the bottom retainer 48 may be foam, plastic or any other suitable material affixed to the side portion 14 or formed therein.

FIG. 5 shows the bottom portion 16. The bottom portion 16 is a circular element adapted to be fitted snugly into the now-cylindrical side portion 14 and rest upon the bottom retainer 48. As with the top portion 12, the bottom portion 16 may be constructed of plastic, cardboard or other similar materials.

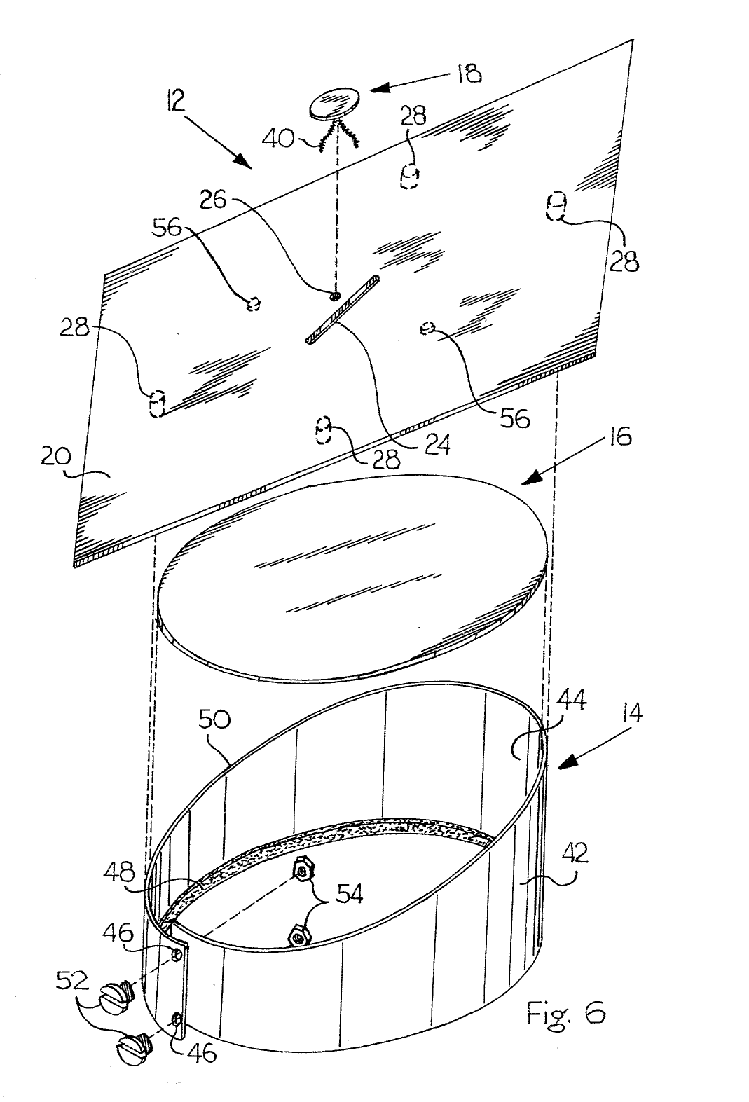

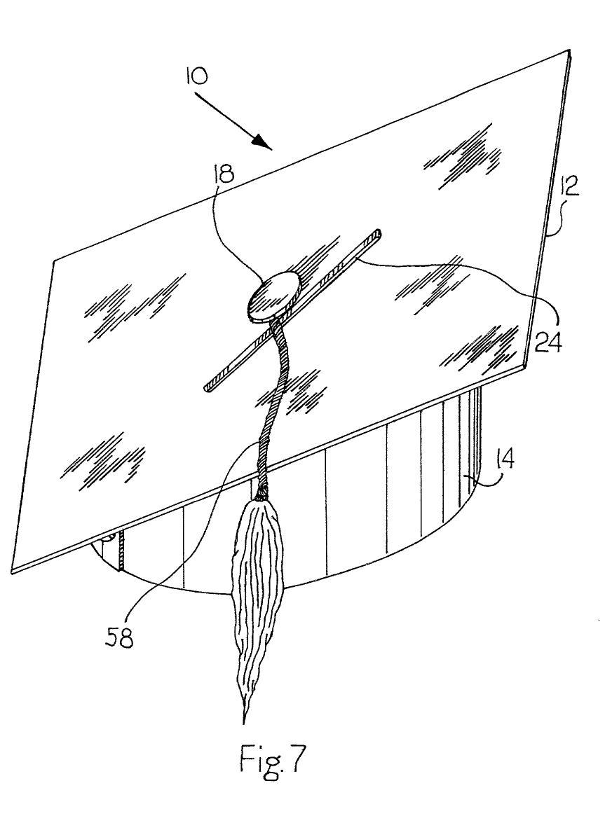

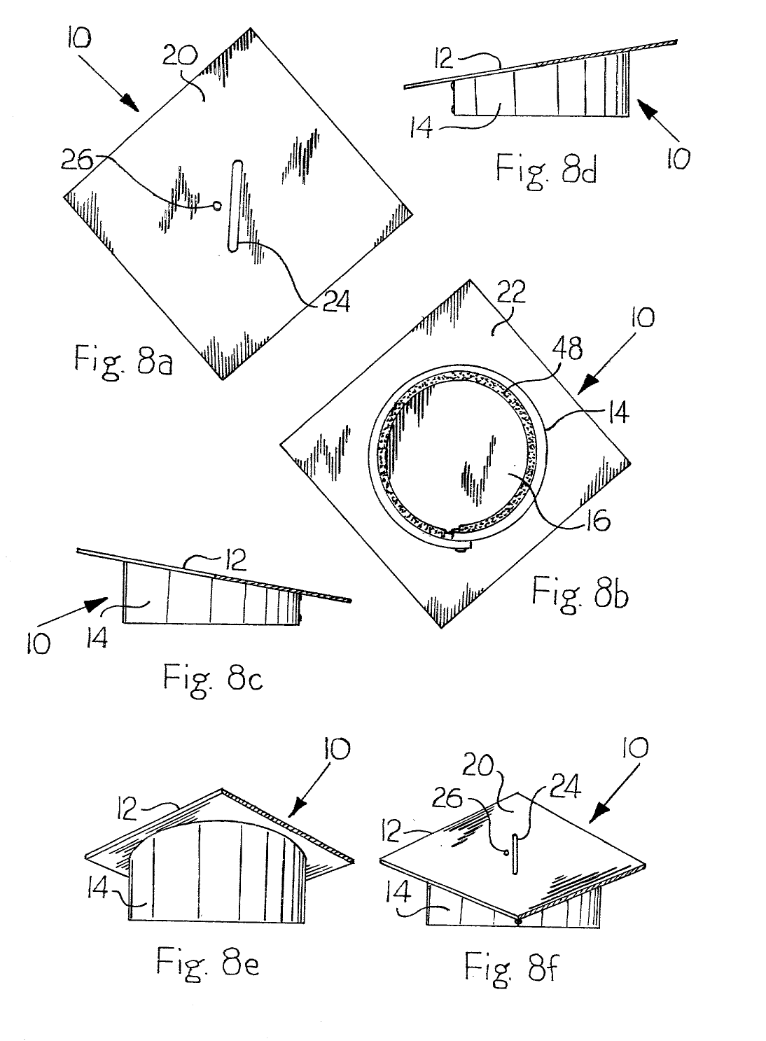

In creating a kit, the elements of the present invention may start out as a collection of flat, easily stored and shipped elements. As seen in FIG. 6, the graduation capshaped holding device 10 is assembled as follows. The attaching element 40 is inserted through the attachment retainer orifice 38 on the attachment retainer 36 (on the retainer element 18). Next, the attaching element 40 (in this embodiment, a bendable wire) is positioned through the tassel retainer orifice 26, loosely fixing the retainer element 18 to the top portion 12. Once in place, the retainer element 18 may be used to hold the graduation tassel 58 to the top portion 12, allowing the graduation tassel 58 to dangle over the side of the top portion upper surface 20. To assemble the side portion 14, the side orifices 46 of one side of the side portion 14 are aligned with the side orifices 46 of the other side of the side portion 14 by bending or curling the side portion 14 into a cylindrical shape. Once curled, the upper edge 50 of the side portion 14 is slanted.

In order to attach one end of the side portion 14 to the other end of the side portion 14, a fastening mechanism 51 is utilized. In the preferred embodiment, the fastening mechanism 51 includes bolts 52 and nuts 54. The bolts 52 are fed through the side orifices 46 and the nuts 54 are threadedly engaged with the bolts 52. This nut and bolt assembly provides secure fixation of the ends of the side portion 14. Other fastening mechanisms are envisioned, such as binder clips, paper clips, glue, a hook and loop arrangement or any other suitable fasteners. It should be noted that, for example, if glue is to be utilized, there is no need for the side orifices 46. However, using non-permanent fasteners will allow the user to disassemble the present invention to a completely flat configuration for storage or shipping purposes.

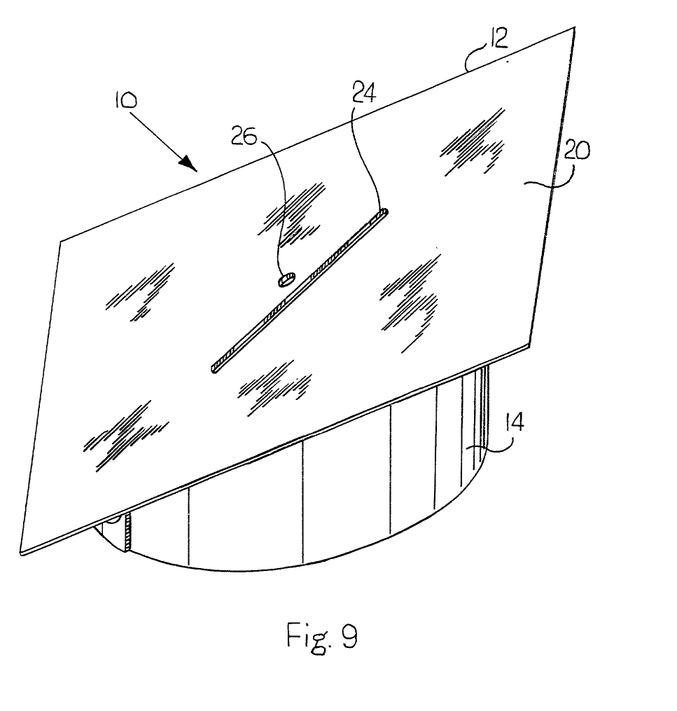

After assembling the side portion 14, the bottom portion 16 is placed through the now-cylindrical side portion 14 and rested on the bottom retainer 48. Finally, the top portion 12, with the retainer element 18 attached, is rested upon the upper edge 50 of the side portion 14. The positioning elements 28 are used to hold the top portion 12 on the slanted upper edge 50 of the side portion 14. Again, as noted above, the weight bearing positioning elements 28 are positioned at the upper and lower regions of the slanted edge 50 of the now-cylindrical side portion 14. Consequently, the side positioning elements 56 are positioned so as to disallow lateral movement of the top portion 12. While both the weight bearing positioning elements 28 and side positioning elements 56 secure the top portion 12 to the side portion 14, they still allow for quick and simple removal of the top portion 12 from the side portion 14. Once assembled, a graduation cap-shaped holding device 10 is created, as illustrated, with a graduation tassel 58 attached, in FIG. 7. FIGS. 8 and 9 show multiple views of the present invention 10 as finally assembled and ready for use.

In use, a party attendee may insert a greeting card, envelope or other flat item through the slot 24 and into the present invention. In this manner, the card or envelope is safely retained within the present invention and unable to be dropped, mishandled or otherwise lost or misplaced. The present invention is cost-effective in its manufacture and easy in its assembly. Further, the graduation cap-shaped holding device 10 is easily disassembled and flattened for convenient storage and/or shipping. Overall, the present invention is an aesthetically pleasing holding device for a graduation party.

This invention has been described with reference to the preferred embodiments. Obvious modifications and alterations will occur to others upon reading and understanding the preceding detailed description. It is intended that the invention be construed as including all such modifications and alterations.

I claim:

1. A graduation cap-shaped holding device, comprising:
a cylindrical side portion having an upper edge and a lower edge; and
a square-shaped top portion configured to rest on the upper edge of the cylindrical side portion and having a slot configured to receive an object or allow the object to pass therethrough.

2. The graduation cap-shaped holding device of claim 1, wherein the upper edge of the side portion is angled.

3. The graduation cap-shaped holding device of claim 2, further comprising at least one positioning element attached to and projecting from a lower surface of the top portion and configured to retain the top portion adjacent the angled upper edge of the cylindrical side portion.

4. The graduation cap-shaped holding device of claim 3, wherein the positioning element is one of cork, felt and plastic.

5. The graduation cap-shaped holding device of claim 1, further comprising a retainer element attachable to an upper surface of the top portion and configured to retain a tassel against the top portion.

6. The graduation cap-shaped holding device of claim 5, further comprising an attaching element secured to the retainer element.

7. The graduation cap-shaped holding device of claim 6, further comprising a tassel retainer orifice extending through the top portion and configured to receive an attaching element.

8. The graduation cap-shaped holding device of claim 5, wherein the attaching element is one of a bendable wire, knob and clip.

9. The graduation cap-shaped holding device of claim 1, further comprising a bottom portion connected to the lower edge of the cylindrical side portion.

10. The graduation cap-shaped holding device of claim 9, further comprising a bottom portion retainer configured to retain the bottom portion adjacent the lower edge of the cylindrical side portion.

11. A graduation cap-shaped holding device kit, comprising:
an elongated flat side portion having two ends, an upper edge and a lower edge and configured to be curled into a cylindrical side portion; and
a square-shaped top portion configured to rest on the upper edge of the cylindrical side portion and having a slot configured to receive an object or allow the object to pass therethrough.

12. The device kit of claim 11, further comprising a fastening mechanism configured to attach the ends of the flat side portion when curled into a cylindrical side portion, such that the cylindrical side portion is held in a cylindrical shape.

13. The device kit of claim 12, wherein the fastening mechanism is one of a nut and bolt arrangement, a clip, an adhesive, and a hook and loop arrangement.

14. The device kit of claim 12, further comprising at least one side portion orifice on at least one end of the side portion, wherein the fastening mechanism cooperates with the side portion orifice, such that the side portion is held in a cylindrical shape.

15. The device kit of claim 11, wherein the object is one of a greeting card, an envelope, a note, money and a flat item.

16. The device kit of claim 11, wherein the upper edge of the cylindrical side portion is angled.

17. The device kit of claim 16, further comprising at least one positioning element attached to and projecting from a lower surface of the top portion and configured to retain the top portion adjacent the angled upper edge of the cylindrical side portion.

18. The device kit of claim 11, further comprising a retainer element attachable to an upper surface of the top portion and configured to retain a tassel against the top portion.

19. The device kit of claim 11, further comprising a bottom portion attachable to the lower edge of the cylindrical side portion.

20. A graduation cap-shaped holding device, comprising:
a cylindrical side portion having an upper edge and a lower edge, wherein the upper edge of the side portion is angled;
a square-shaped top portion configured to rest on the upper edge of the cylindrical side portion and having a slot configured to receive an object or allow the object to pass therethrough;
at least one positioning element attached to and projecting from a lower surface of the top portion and configured to retain the top portion adjacent the angled upper edge of the cylindrical side portion;
a retainer element attachable to an upper surface of the top portion and configured to retain a tassel against the top portion, the retainer element having an attachment retainer secured to a lower surface of the retainer element, the attachment retainer having an attachment retainer orifice extending through the attachment retainer;
an attaching element secured to the retainer element via the attachment retainer orifice;
a bottom portion connected to the lower edge of the cylindrical side portion; and
a bottom portion retainer configured to retain the bottom portion adjacent the lower edge of the cylindrical side portion.
